(19) United States
(12) Patent Application Publication
(10) Pub. No.: US 2014/0154651 A1
(43) Pub. Date: Jun. 5, 2014

(54) Quantifying peak cognitive performance using graduated difficulty

(71) Applicant: Sync-Think, Inc., Boston, MA (US)

(72) Inventor: Matthew E. Stack, Boston, MA (US)

(73) Assignee: Sync-Think, Inc., Boston, MA (US)

(21) Appl. No.: 13/694,462

(22) Filed: Dec. 4, 2012

(51) Int. Cl. G09B 21/00

(52) U.S. Cl. CPC G09B 21/00
USPC 434/236

(57) ABSTRACT

A method to determine the subject's peak cognitive performance using smooth pursuit tracking tests. The method utilizes instantaneous performance feedback to accurately quantify the subject's peak cognitive performance by changing the difficulty of the test in response to the subject's performance.

### FIELD OF THE INVENTION

This invention relates to cognitive assessment that pertains to a smooth pursuit cognitive performance test in which test difficulty varies to establish peak cognitive performance.

### BACKGROUND OF THE INVENTION

As shown in U.S. patent application Ser. No. 13/507,991 filed Aug. 10, 2012 incorporated herein by reference, it is now possible to measure cognitive performance using eye tracking to an accuracy and consistency level not heretofore possible. While smooth pursuit eye tracking is known, the ability to eliminate environmental factors and the position of the head provides the opportunity to make quantitative measurements of cognitive performance that are reproducible and can be correlated to both cognitive performance and cognitive impairment.

Thus, while smooth pursuit eye tracking in the past has yielded relatively coarse results such as shown in US Patent Applications 2011/0205167 and 2008/6309616, in which a moving dot is made to trace a particular pattern, the ability to accurately measure the lead and lag times of the eyes of an individual tracking a dot on the screen and measure for instance the regularity by which an individual can track a dot yields a new paradigm in eye tracking. For instance, while Messengill shows how a dot can be moved in various patterns, there is no indication of the difficulty of the test, or any correlation with test difficulty.

With the above new-found cognitive performance paradigm, not only can cognitive performance be quantified, but it is now possible to assess an individual's peak cognitive performance by stressing the individual in a controlled manner to ascertain peak cognitive performance with a high degree of accuracy.

The utility of accurately accessing peak cognitive performance lies in more accurate diagnosis of impairments, better understanding of drug testing reactions and better localization of a mental impairment such as better detection of brain injury and its effects.

Moreover, one can also quantify cognitive enhancement. Note that cognitive enhancement involves improvement in thought speed, reaction time, short term memory recall and simultaneity of thought akin to parallel processing in the computer arts.

It has been thought that by massively increasing the frame rate for high performance eye tracking that one can obtain better data. However, aside from the artifacts that naturally accompany high frame rates, the environmental noise including sources of light, head movement and density of tears cause high speed trackers to develop error or jitter at high frame rates. This error swamps the distance the eye moves between consecutive frames. Thus, it is possible to degrade the measurements involved in determining gaze direction if one samples too fast.

However, it is also possible to degrade the measurement by sampling too infrequently, which results in missing saccades and any variations of the eye movement while following the path. It has been found that the ideal frame rate is between 15-150 frames per second.

The industry focus on frame rate for accurate cognitive measurements has been found to be somewhat misguided, as to what is necessary to measure the function of the brain as the eye tracks the moving dot. This has to do with the eye muscles and the thought processes, automatic, reflex-based, autonomic, or cognitive, involved in tracking a moving dot. It has been found that cognitive performance is better measured by measuring the regularity of the variability of the eye in anticipating the next position of the dot. This is because this metric measures the effectiveness of the automatic nature of the circuit in the brain responsible for anticipation.

By way of further background, in the current state of cognitive testing, several dominant paradigms of testing exist, which include surveys, reaction time tests, motion based testing, imaging, biomarker tests and eye tracking.

The survey is perhaps the oldest mechanism and method for testing cognitive impairment. This traces its origins back to the early observation of a physician asking the patient or subject about how they felt to determine the severity of a reported impairment to diagnose the cognitive impairment. This has evolved with time to a full third party assessment of the patient's cognitive performance through surveys and questionnaires run by a trained physician or clinician. Today, these surveys take place in the form of online tests with multiple choice or open-ended questions, administered from anywhere from in a fairly controlled environment to testing at home where the patient controls the environment. These surveys are also the most dominantly used paradigm of cognitive testing as the format in which they are administered is the most open ended and adaptable, giving flexibility to the test designer.

Despite its flexible format, surveys suffer as an accurate cognitive testing method because their inputs are qualitative. Qualitative surveys lend way to a vague metric, which makes it difficult for the test taker to give accurate answers. In addition, the scoring algorithm and calculation utilized to form conclusions from these surveys too become a qualitative one, giving the test administrator too much room for subjective analysis of the survey answers.

Reaction time testing builds on surveys by measuring and testing one's reaction time to a certain question to determine cognitive performance. These questions come in simple and complex form. A simple question might include pressing the button whenever an object appears on the screen. A more complex question might involve the patient having to make a decision about something that's presented, for instance it might entail pressing the button when an object appears on the screen only if that object is green in color or only if that object can be used in a kitchen. Thus, the reaction time for such a question is based on the patient or subject's decision-making process involving recall or memory and other associated functions. The lag time associated with responding to these reaction time questions is usually measured in milliseconds today, with the use of computers.

Reaction time tests, however, are highly variable from test to test, resulting in fairly low and unstable “test-retest reliability”. The low “test-retest reliability” stems from one main problem. The problem is that the brain does not appear to react in the same way to the same stimuli every time. In other words, the same test administered in some circumstance may be administered in exactly the same circumstance and exactly the same situation at a time later, yet still yield different results due to the many variables in play regarding the test taker. Such variables include the degree of attention, emotional changes, metabolic rate and fatigue of the test taker. Also, the thoughts occurring in the patient's mind at the time of the test as well as the preconditioning associated with the test itself can affect the performance of the test taker's reaction time. It is also important to mention that these variables may be changing throughout the duration of one test, let alone different for one test than another. This is magnified by at home or portable field-administered testing. All these variables also factor into some of the sources of error with the “test-retest reliability”.

Due to the low “test-retest reliability”, reaction time tests are generally administered a number of times and that number can be anywhere from a dozen to hundreds or thousands of times. The results from these multiple tests are then averaged together. This then adds on more sources of errors that come with mathematical methods such as standard deviation, variation and mean, which aggregate data into a single, compressed metric. The problem with this and its associated data cleansing and normalization methods of dropping statistical outliers is that altogether, the end result is extremely variable on the decisions one makes while cleaning up the data.

Another paradigm of cognitive testing involves the analysis of patient movement or motion. The most common type of motion testing being balance based testing. Balance based testing tests one's vestibular function, which is the function associated with one's balance. The vestibular function is primarily driven by the brain's ability to detect and monitor certain inner-ear channels and other sources of sensory data for the human body orientation, such as the positioning of limbs and stability of the body and the core. Therefore, the theory of balance-based testing is that impairment in the brain's circuit between monitoring these balance-sensory inputs in the brain and the mechanical feedback of motion of the body will result in the impairment of one's ability to balance. Examples of balance based tests include asking a patient to walk in circles, walk on top of objects, which can be rounded or shaped in ways to purposefully throw the patient slightly off balance or off guard, in order to test one's ability to rebalance or react to the external stimuli. In some cases, a patient is asked to simply sit or stand while a set of optics or movement measuring sensors and devices are employed to determine if the patient is moving in some way that may be predictive of a set of movement that is commonly seen when a cognitive impairment is present. The data generated by these motion-testing processes is often continuous data streams and they are often at a level of resolution that makes smoothing algorithms viable because the impact of the filter or algorithm does not overwhelm the data set. As a result, the data sets produced from these continuous type tests are superior to the reaction test paradigm or the imaging paradigm.

However, motion based testing processes have problems of their own. Most of the motion based testing involves technologies and devices such as cameras and mechanical sensors like accelerometers and gyroscope sensors. These technologies are unfortunately very noisy due to the impact of the environment and normal patient movement. In fact, the signal to noise ratio for the human body movement tends to be very difficult to pick up, or if the features are present, they are very difficult to analyze using normal algorithms. As a result, the algorithmic complexity for filtering out the signal from the noise in some cases introduces more different types of error that make motion based analysis unpredictable and unreliable. In other words, algorithmic analysis is no better than subjective observation, and so this testing paradigm fails as a quantitative metric in practice in the clinic or lab.

Another form of cognitive testing involves the use of what is known as imaging technologies. Imaging technologies are not necessarily limited to optical but could also include signaling and signal analysis. Such technologies include CT, fMRI, magnetic resonance imaging, images of the brain, as well as electroencephalographic (EEG) or magneto-encephalographic (MEG) technology. EEG and MEG technologies monitor the electrical and magnetic characteristics of the brain as produced by the triggering of neurons and metabolizing of chemicals in different sections of the brain as thoughts occur and process inside the brain. In this form of cognitive testing, baseline versus abnormal or off state analysis can be done by predictably anticipating which regions and circuits of the brain will fire for the baseline testing before an impairment. This allows for a quantitative assessment by comparing where the parts of the brain trigger or trigger sequentially at a slightly delayed or offset rate than that of the baseline normal state, or if different parts of the brain trigger in response to certain tests due to neuroplasticity. Such differences would then suggest to the clinician or physician that there was some form of impairment in that portion or pathway of the brain. Similar image comparison can be done for EEG and MEG's waveform signals by analyzing whether certain parts of the brain are timed differently.

Leaving aside the time intensive process of calibration, the problem with imaging technologies is that each of these technologies produces an output with a low signal to noise ratio. This is because the background, static state of the mind, tends to include and involve a fair amount of background noise. This then makes the process of analyzing the output images or signals such as filtering this noise to deduce what part of the brain signal was actually illuminating in response to the test stimuli quite challenging. In the case of EEG and MEG, this output analysis and filtering process is even more difficult as majority of the waveform data points are very brief spikes that even through the use of the best Fourier transforms or filters, isolating the signal is very difficult. Even when the signal is successfully isolated, because the artifact is so brief, it can often be missed and even when found, the idea that the signal is the same strength on successive tests is a statement that is hard to verify in practice. Due to this difficulty with picking out signal to noise, the majority of applications that use EEG, MEG or other imaging technologies, tend to employ signal filtering algorithms of such high dithering state or such high filtering level that the underlying signal becomes lost in the analysis or smoothed over so much that it becomes indistinguishable from other artifacts such as the eye blinking or thinking a thought.

Biomarker or diagnostic based cognitive testing involves looking for biomarkers or trace elements in the bloodstream of a patient in response to certain parts of the brain breaking down or metabolizing chemicals in a certain way. Thus, they link one's cognitive ability to the amount of byproduct of damaged neurons or associated byproducts of cognitive damage as they break down floating in the bloodstream.

The biomarker based testing too, however, has disadvantages as a cognitive test method. As a biological system based testing, one downside of this type of testing method is that it is intrusive. In other words, this class of testing requires some body fluid sampling, which can include anything from an intrusive sampling or nonintrusive sampling of some biological process, such as urine sampling. Sampling related variables such as the sampling method, time of day of the sampling, the metabolic process state at sampling, also introduces sources of error and variability in the data. Another problem is that the output data is not very fine tune resolution grade for several reasons. One reason is that the output data from the biomarker tests tends to be a measure of some kind of very high-level function that occurred that is unknown. Another reason is that the results are dependent on the biomarker's ability to detect the compounds of interest as neurons are breaking down. Furthermore, the output data does not provide any information regarding the location of the brain damage or break down matter. Even presupposing that the resolution of these biomarkers advanced to where they could detect the type of subtleties analytically necessary to isolate the brain damage location, they will never reach a point to provide the x, y, z coordinates inside the brain where damage occurred, nor predict the magnitude of the damage. Another problem with biomarker based testing is that it tends to be fairly expensive relative to noninvasive, less intrusive behavior attribute testing methods.

One of the most promising methods currently employed for cognitive testing is eye tracking because optical testing is noninvasive, shown to have high test-retest reliability and generates a fairly continuous, quantitative data set, allowing for various types of analysis. It is this type of testing that is showing the most immediate applicability, and therefore the type that we expand on in this patent.

### Smooth Pursuit Eye Tracking

Among eye tracking, smooth pursuit eye tracking is currently the most promising method of cognitive testing. In smooth pursuit eye tracking, a patient is asked to follow a target that is moving on a screen while a patient's eyes are monitored to see how closely the patient can follow that target on the screen or on the projected monitor. It has been discovered by others in the prior art that patients that are able to track the target very carefully and smoothly with small movement, have a greater level of cognitive ability or stability. On the other hand, patients that are less predictable or more erratic in their tracking of an object that is moving in a smooth path are shown to have some form of cognitive impairment or some detrimental attribute of the circuit in the brain that is responsible for tracking smoothly moving objects. This part of the brain that is responsible for tracking smooth movement in objects appears to involve several complex higher order functions within the brain, in addition to the lower order functions involved with the basic vision. Thus, if there is lack of ability or impairment in the ability to follow smoothly moving objects, it is safe to assume that there is likely some impairment in some portion of the brain that's involved in the circuit. What is also intriguing is that the circuit that is involved in performing smooth pursuit appears to track all around the brain from the optical processing center to the rear of the brain, to the neo cortex, with respect to time and anticipation. Thus, the breadth of the test and the breath of the number of circuits required to do the test are actually a tremendous feature of smooth pursuit analysis.

For a long time, smooth pursuit eye tracking has been used by physicians as a simple test to gage whether a patient has a concussion for a long time in the form of linear smooth pursuit. The simple test involved holding a finger up and moving that finger to the left and to the right while asking the patient to follow their finger with their eyes. If the patient's eyes jumped around somewhat sporadically while trying to do so, a movement now known as “saccading”, then the patient was suspected of some form of impairment in smooth pursuit, cognitive ability. The naming comes from the fact that the patient's eyes are asked to move in only one line direction, from one extreme to the next along a same line or axis. Today, the linear smooth pursuit eye movement test has been translated into a number of implementations and embodiments including mechanical devices that swing an object from one extreme to the next to an eye tracking method, where a monitor or a projector moves a dot or target.

Linear smooth pursuit eye movement has many downsides. One downside is that the data produced from the linear movement has major disruptions if digitized because the extremes of the eye movement from one end to the next involve the eyes changing the directions in the opposite direction that they entered the corner into. The result of this is that the eye data, for instance, the location of the eye that is being tracked, stops to the end of the data set and then reverses. Unfortunately, when performing analysis of variation in the difference between the eyes and the target location, the data of these extreme corners need to be canceled and nulled out for an accurate data analysis. This is because there's a fairly large learning effect present for the patient's brain as they begin to realize what the extremes of the linear motion are. This then leads to anticipating, thus slowing down their eyes to some degree before reaching the edge of the target extreme, which is no longer an accurate tracking a moving object with the eyes. Also, as the patient learns the locations of the extremes of the test, they stop smooth pursuit movement to the extremes and instead begin saccading over to the edge. The process of making saccades over to the edge of the test is a negative one because it involves a different part of the brain. It should also be noted that saccading is a more primitive function than smooth pursuit movement. As linear smooth pursuit eventually involves the patient to change their test taking method to merely a saccade, it is a very flawed type of smooth pursuit.

A significant improvement over linear smooth pursuit is the circular smooth pursuit eye movement. Circular smooth pursuit involves a target object moving in a circular motion, clockwise or counter clockwise, while tracking to see whether the eyes are following the smooth pursuit object. The data from circular smooth pursuit does not suffer the same problem as linear smooth pursuit suffers because of the continuous nature of the data set. As circular smooth pursuit's data set moves in a full circular form, there are no breaks or edges like those in linear smooth pursuit. The circular smooth pursuit eye movement generates a continuous set of data of x, y coordinates and a time stamp of the eye as well as the target location. Thus the analysis of circular smooth pursuit eye movement involves some form of comparison of where the eye should have been versus where the eye was actually looking. Some of the most popular analytical techniques to do this include analysis of variance, standard deviation, mean, median, mode and other statistical methods including correlation, auto correlation and regression. These analytical techniques help characterize the variation or difference between the eye and the target position in a compressed, smaller set of numbers that summarizes the entire data set. These few numbers are then further compressed for a scoring system or a performance ranking system.

The benefits of continuous smooth pursuit eye movements, which circular smooth pursuit generates, have been discussed in the prior art in the patent literature and the general neuropsychology and neuroscience literature, such as the complexity of the tests and the breaths of the circuits involved.

However, circular smooth pursuit has a few problems including some that this patent improves upon and addresses. One major downside of the circular smooth pursuit is that there is still a “learning effect” present. Because the target moves in a fixed circular path, the test taker can eventually memorize the radius of the circle and trace a circle with their eyes in a fairly predictive manner. This is a problem because when the test takers begin to memorize or learn the shape of the target motion, the test takers tend to revert back to some form of saccading. As mentioned before, saccading is different from the higher brain functions involved in smooth pursuit. Thus, the saccades can distort the test results and no longer testing the function of the brain of interest.

Both linear smooth pursuit and circular smooth pursuit have another common problem: the blink issue. Whenever the patient blinks, the data portion of the blink has to be nulled out. This causes the data set to be broken up into multiple long segments, which affects the analysis of the data. The detection and filtering of blinks is known and described in the prior art.

### Eye Tracking Technology

One of the major problems with smooth pursuit eye movement analysis is that it is highly reliant upon the eye tracking techniques used to find the eye position. Before, the patient's eye position was merely observed by a physician or a trained clinician during the test. Currently modern practice utilizes eye tracking technology to determine the eye position, which is more objective, quantitative and accurate.

Despite the technological advancement in eye tracking, eye tracking systems or devices have many problems. One problem is that eye trackers require a great amount of calibration. Often times the calibration of the eye tracker takes a tremendously longer amount of time than actually running the test. A trained professional can spend anywhere from 15 minutes to 30 minutes or more for the calibration process alone. This is because of the many variables that differ from person to person that affect eye tracking such as facial features, eye color, the characteristics of the surface of the eye and the inter-ocular distance. The inter-ocular distance is the distance between the eyes and it varies across a population. On top of these variables, calibration is required to take into account the environmental differences as well. Although some patents and literature have proposed solutions of self or auto calibrating to fix the calibration problem, but these calibrations are not very accurate. Another problem with eye trackers is that they are fairly expensive and complex, thus requiring a trained professional, which adds onto the cost.

### Eye Tracking with Mechanical Input Testing

Existing technologies have contemplated the use of mechanical input source to follow or trace a moving icon, picture or dot on a computer screen as a test of alertness. These tests and the patents associated with these follow research into a field where alertness is based on the ability of one to follow the moving picture. However, these technologies do not focus on the algorithm to analyze the data captured by such tests to effectively and quantitatively determine if the user has a cognitive impairment and perhaps even what type of cognitive impairment the user has. Instead, these tests simply focus on the qualitative ability of someone to follow a moving target on the screen, and especially as a metric of alertness.

### SUMMARY OF INVENTION

In order to quantify peak cognitive performance, in the subject invention involving eye tracking of, for instance, a dot on a screen, rather than moving the dot in a regular and predictable fashion, an icon or dot is made to move in a pattern that can be varied to control and controllably set the difficulty of the tracking test. Note that the subject system is applicable to a number of different tests including eye tracking, mechanical tracking or a hybrid combination thereof. Moreover a wide variety of input devices can be used including a number of sensors and those involving different measuring technologies either eye, mechanical, hybrid, or other input driven, for instance, via sensors, or measurement technologies.

Additionally, there are a number of metrics useful in determining cognitive ability when using smooth pursuit cognitive testing. These include anticipatory timing, variability, reliability, and predictability and are defined as follows:

For purposes of the subject invention anticipatory timing means measuring the lead or lag time of an individual's response to tracking a smooth pursuit target icon to anticipate the future position of the icon.

Variability means the distance error as the individual follows the target icon.

Regularity means the consistency of any smooth pursuit tracking measurement, with maximum consistency meaning that the errors over time are the same.

Predictability means the degree to which the test subject's past input and errors can predict the next input.

There are thus a number of different metrics by which one can quantify and assess cognitive behavior that are described in U.S. patent application Ser. No. 13/506,840 filed May 18, 2012 and Ser. No. 13/507,991 filed Aug. 10, 2012.

In one embodiment, the ability to track a moving icon better measures cognitive performance when the smooth pursuit icon movement pattern is varied in complexity, which in turn varies the degree or level of difficulty of the eye tracking test. It has been found that by varying the degree of difficulty one can more accurately assess peak cognitive performance.

In particular, the degree of difficulty is increased in stages until an initial failure to track the moving icon or dot occurs, which establishes a threshold. Once the failure threshold has been established, the difficulty level of the test is oscillated around an average difficulty centered on or about the failure threshold, and this oscillation begins with a difficulty level just below the failure threshold. The subject system then measures the regularity of the eyes' response, with more regular tracking indicating greater cognitive ability and with less regular tracking indicating cognitive impairment. It is a finding of the subject invention that the degree of impairment is more accurately measured at just below the point at which the eye is no longer able to track the moving icon or dot, or just below a point of failure that is established as a result of a controlled program of difficulty that stresses the patient in order to establish a maximum in the peak cognitive state of performance. Thus, by gradually increasing the difficulty up to a failure threshold and then measuring the response of the eye, one is more able to accurately determine peak cognitive ability. Note that pattern complexity can be varied in a number of ways including dot speed, dot acceleration, path undulation, undulation amplitude, undulation frequency and path pattern changes.

More particularly, for impairments of attention, including attention deficit hyperactivity disorder (ADHD) and mild traumatic brain injury (mTBI), the subject system more accurately detects peak cognitive performance than do systems in which the degree of difficulty of the test is not altered. This is because impairment sometimes manifest itself, especially initial impairments, as a degradation of maximum ability, instead of as a detectable reduction in some baseline. Tests measuring only baseline cognitive ability will not measure peak impairment until the degradation in peak ability has reached a level severe enough to impair normal baseline state. For instance in trying to measure the onset of Alzheimer's disease, trying to detect from a baseline does not give enough early warning because the impairment drop off relative to a baseline occurs much like in the disease progression. However by measuring peak performance for instance on a yearly basis results in peak performance data what will disease over time in a manner that is recognizable long before baseline analysis yields an indication. By bringing the test subject up to the point of failure and oscillating the degree of difficulty around this threshold one can sense peak cognitive performance, with the peak being defined as the point at which the individual fails to track the dot.

In one embodiment the present invention is a hybrid eye and mechanical movement cognitive test in which a test subject is made to trace a moving dot while following the moving dot with his or her eyes. Thus, eye tracking and the ability to move a mechanical input, such as a pen, to follow a corresponding dot on a tablet or screen assures the highest accuracy of peak cognitive ability. As a result in one embodiment the test is a combination of continuous motion normal dexterity testing and smooth pursuit eye movement testing. The benefits and features of both are brought into an environment where these variables are tested in parallel and simultaneously, independent of each other, in a complex multimodal multisensory cognitive test.

The test can be broken down into four different phases: target matching, cognitive calibration, change of degree in difficulty and stasis.

The test initiation constitutes the first phase of the test called target matching. The test begins as a prerecorded or pre-scripted initial set of path motion for an icon to follow the screen. The user attempts to match the location of that target using some type of mechanical input, or visual/optical input.

The second phase of test administration is the cognitive calibration. As the target advances and continues to move using some type of fluid motion, typically in a line, an arc, a curve or a sinusoidal shape, the user initiates his or her attempt to follow and replicate that path. In this phase, the user begins to match and adapt to the test, assess how difficult the test will be and also begins to memorize or learn how to modulate his or her mechanical extremities in order to best match the target moving on the screen. This initial phase is critical and pivotal in measuring how quickly the user can learn to match the moving target.

As the test continues, the test begins to stabilize as the patient is normalized over some period of time. At this point, the user is thought to be perfectly tracking the movement of the target as best as possible at the current state of ability and to have overcome the learning effect through a simple amount of memorization of how the test will proceed.

This leads to the next phase called change of degree of difficulty. This is when the test takes into account the performance of the user and incorporates this into changing the parameters or behaviors of the target itself to change the degree of difficulty that the user is subjected to. For a continuously semi-linear motion, the velocity can be made to accelerate. For a continuously arcing path, the radius of curvature may be made to decrease, increasing the curvature angle. For a sinusoidal pattern, the amplitude or the frequency of the sinusoidal motion may be made to increase, which over a period of time will become a more chaotic motion, making it very difficult for the user to follow and match the target. Such various parameters are changed to increase the difficulty of the test to test the user's performance. Degree of difficulty is therefore thought to be specified as a function of a number of variables, including velocity of target, arc of target, predictability of motion path, visibility, continuity of visibility, frequency of alteration in the variables aforementioned.

By the end of this phase, the test has now quantified the maximum state of cognitive performance by having ramped up the difficulty of the test to a point where the user can no longer respond or match the increasing complexity of the test difficulty dimensions. However, it should be noted that the objective of this phase is to determine the user's maximum state of cognitive performance as quickly as reasonably possible via an accelerated ramp up of difficulty. Thus, the user's maximum cognitive ability quantified in this phase of the test is a fairly accurate approximation, but an approximation nonetheless.

The last phase of the test is called stasis. The objective of this phase is to take additional time than the previous phase to hone in, clarify and get further data points around the user's cognitive ability threshold. In order to meet this objective, the difficulty of the test is oscillated in this phase. However, the test does not blindly oscillate the difficulty, but makes use of the maximum ability that the test taker achieved from the previous phase and oscillates the difficulty of the test around that threshold. In other words, the difficulty of the test is modulated to be slightly harder and then slightly easier around the area where the patient is expected to be maximally tested and pushed, which was found from the previous phase. Through this oscillation, the test taker is slowly pushed to difficulty levels higher incrementally in order to get further confirmation that the difficulty level at this stage is really a representation of the most difficult stage level the patient can endure. The result is a series of readings, which measurements are the most meaningful and important data and constitutes the heart of the analysis of the user's cognitive ability.

There are two variables of this last phase that are very important to achieving an accurate final maximum cognitive performance of the test taker, namely, frequency of oscillation and the length of time of this phase.

The frequency of oscillation is very important because an oscillation frequency that is too fast will not allow the test taker to adapt, whereas an oscillation frequency that is too slow could bore the patient. In both cases, the resulting data will not as useful as it could be. Thus it is important that the oscillation period is just long enough to allow the test taker to catch his breath, cognitively speaking, and then re-engage to push to a harder level of difficulty, but not too long to bore the test taker.

The length of time for this phase of the test is also very important. If this phase goes on for too long, other cognitive effects may begin to be in evidence such as distraction, boredom, fatigue, lethargy, lack of will, or neural metabolic exhaustion, which would deteriorate the various cognitive effects of interest. Thus, the timing and duration of this final phase is absolutely critical.

It is important to note that the addition of mechanical input in parallel to the visual input does not confound the test or make it overly complex to mask the effect the test is trying to analyze via smooth pursuit movement. In fact, this enhances the effect the test is trying to analyze. Because the smooth pursuit movement task is a continuous attention task that demands the user's full attention, the addition of the mechanical motion demands an even higher attention threshold. This ensures that the brain of the user is very unlikely to wander during the time he or she takes the test. Therefore, the invention requires a high cognitive load without overloading the patient. This means that this test is an ideal type of cognitive test because the upper bound cognitive load adapts in a relatively dynamic and variable manner to the upper bound of the cognitive load of a patient.

In other words, the test gets more difficult as the patient performs better and the test is less difficult for patients that perform less well or that have a cognitive impairment.

It is also important to not confuse the idea of the parallel mechanical task addition of the mechanical motion and the eye smooth pursuit, with a concept known in cognitive literature as dual tasking. Dual tasking utilizes what is known as sequential decision logic process, which requires the same part of the brain to make two sequential decisions before responding to a stimulus. The invention however is not dual tasking as it utilizes a parallel decision logic process. A test that utilizes a parallel decision logic process requires two different parts of the brain, and thus can be activated in parallel, allowing two different logical decisions to be made simultaneously to respond to a stimulus. In other words, the visual smooth pursuit and the mechanical task utilize two different regions of the brain, and thus do not interfere with one another or effect the cognitive test results in a negative manner.

The platform of the invention is a computing device with some type of screen to run and display the test on, such as a personal computer and a monitor, a laptop computer or tablet computer.

Many different types of hardware can be used for the mechanical input test to move the cursor on the screen to follow the moving target. It can be a mouse with a cursor on the screen, where the cursor is a secondary icon attempting to follow the target icon, or a finger on a track pad, a stylus with a drawing pad, or a joystick. Also, a rotary source of input where the user is constrained in just a rotational motion, which has been contemplated in the prior art, could be used as the source mechanical input.

Instead of using a type of hardware for mechanical input, the physical location of the user's limbs and extremities can be used in combination with remote three-dimensional positioning technologies. Also one's balance can be used for mechanical input by tracking the user's head position and movement in combination with similar three-dimensional remote-sensing technologies, accelerometers or movement tracking devices.

Furthermore, any combination of these technologies can be used to measure simultaneously multiple limbs, multiple extremities or multiple sources of balance at the same time.

In following for alertness, visual feedback eye tracking has been described in the prior art. It is the combination of these two together with the addition of a functional thresholding for quantifying cognitive-mechanical synchronicity that is the contribution of this patent. The analysis of data from the previous modalities for this purpose of quantifying mental-physical athletic ability has eluded researchers to this date.

In one embodiment, the analytical process step of the invention is divided into a number of algorithmic processing steps. The first step is the administration of the test, in which this part of the analytical process step and programming is associated with presenting a specific type of icon onto the screen. There are also analytical processing algorithms necessary to control the movement and adaptation of movement over the course of the test. The second step involves a set of analytical processes associated with recording the user input into a data file. The user input is an attempt to match the location of the target icon on the screen and the x, y coordinates of the user location and the time stamp is saved. The third step is a tranche of algorithms dedicated to the saving, storage and preparation of the data file, which contains the user and target location data, into one location. This is important for the ease of the next step, namely analysis. This fourth step contains analytical pieces of algorithms that are specifically designed to analyze the data output and assess the ability of the user to follow the target specifically along a set of meaningful cognitive metrics. The final fifth step is a set of algorithms associated with presenting the results back to the user or test administrator. This includes allowing the user or test administrator to analyze, assess and look at reports. For instance, the results can be trend analyzed over time, a demographic or population statistic. The final piece of analytical process step of the invention is a type of coordination algorithm, which is required to coordinate across all of these pieces of analytical processes.

This invention is an improvement over the existing current state of the art in cognitive testing for several reasons. One improvement is that this invention presents the user with multiple channels of information by showing the target on the screen as well as the location of the mechanical input of the user. This is a very important point of the invention as it provides a channel of feedback immediately back to the user of how well they are doing. In addition, as the test varies in difficulty dependent on the user's performance, another channel of information that communicates to the user how the difficulty of the test is changing, increasing or decreasing can be added as well. One possible way to do this could be to change the target icon's intensity, color or size. This then opens up three different channels of communication: target location, user location and test difficulty.

It is important to mention here that because the invention introduces an extremity, which is cognitively different from the eye itself, the invention separates the eye and the tracking of the eye of a smooth-moving target using some physical extremity, which is attempting to replicate the target location on the screen. This separation of eye and tracking of the eye makes showing the user location on the screen a benefit and not a cognitive distraction, as it would be if it were implemented into eye tracking by presenting a dot representing their current gaze position to the user while taking an eye tracking test.

Unlike most cognitive testing, the invention requires almost no time for setup or calibration. The elimination of calibration from the system cannot be overstated. The significance can be represented by the ability to administer this test with only seconds of setup and configuration time, whereas the nearest comparable type of cognitive test in the eye tracking domain takes at least a few minutes but usually up to half an hour to an hour to calibrate for a single patient.

In addition, the test is relatively straightforward. It can be administered with a simple instruction to take a dot representing a mechanical input or extremity of choice and to follow the moving target on the screen as closely as possible. Such a simple instruction can be understood by all ages and can be administered in any multiple sets of languages.

Also, the mechanical testing paradigm of the invention allows for the ability to use a multiple types of input sources, any of which can represent the user's ability to match the target. This wide array of different sources of input for the test makes this test more appealing or suitable for a wider array of individuals.

Other advantages of the invention's cognitive testing system includes low cost and high degree of portability, as this test may be administered anywhere a computer and mechanical input source are available. The low cost derives from the fact that the test only requires a computing device, if not already owned by a user, and a mechanical input device. In comparison, the nearest comparable type of cognitive test in the eye tracking domain requires expensive optics that cost exponentially more as the frame rate of the camera increases.

In one embodiment, the invention is mechanically based and operates with a set of portable peripherals for the testing input. Thus, this system is highly portable, and significantly more portable than for instance, an eye tracker.

### BRIEF DESCRIPTION OF DRAWINGS

These and other features of the subject invention will be better understood in connection with the Detailed Description in conjunction with the Drawings of which:

FIG. 1 is a diagrammatic illustration of the detection of peak cognitive performance when utilizing an eye tracking system to determine the ability to track a moving icon on a screen;

FIG. 2 is a diagrammatic illustration of the detection of peak cognitive performance using a manual icon tracking technique to detect peak cognitive performance;

FIG. 3 is a diagrammatic illustration of the use of the subject system to determine peak cognitive performance by tracking a path, finding the instantaneous vector of movement of an icon on the path, finding a normal to the vector and finding the arc path length between the icon and the finger used to track the icon, with a processor driving an on-screen icon and measuring how far off target the finger is to measure cognitive performance and thence peak cognitive performance;

FIG. 4 is a block diagram of a system for the determination of peak cognitive performance, which includes cognitive performance measurement, followed by the determination of the failure threshold where a test subject fails to be able to follow a moving on-screen icon to set a maximum difficulty threshold, which is then utilized as a threshold about which to oscillate test difficulty in order to pinpoint the maximum, peak cognitive performance;

FIG. 5 is a diagrammatic illustration of the use of a not easily anticipated path for a moving icon which takes out the learning affect, in which the path shape allows the testing entity to vary the test difficulty in terms of varying the velocity, number of lobes, size of a lobe, and rate of curvature of the path, with the variability controlled to make the test harder;

FIG. 6 is a diagrammatic illustration of the path of an icon showing increasing test difficulty, with path variation in terms of frequency and amplitude as well as shape to go from a relatively simple path to a complex path of higher difficulty by increasing the number of lobes and varying the icon velocity of the path;

FIG. 7 is a graph of difficulty versus time for a number of different I, II, III and IV phases in the testing procedure;

FIG. 8 is a graph showing performance score versus time for the I, II, III and IV phases; and

FIG. 9 is a graph showing a decrease in cognitive performance with age showing a downward trend for a baseline image, indicating that peak cognitive performance when trended can predict the onset of dementia, Alzheimer's disease and like mental disorders.

### DETAILED DESCRIPTION

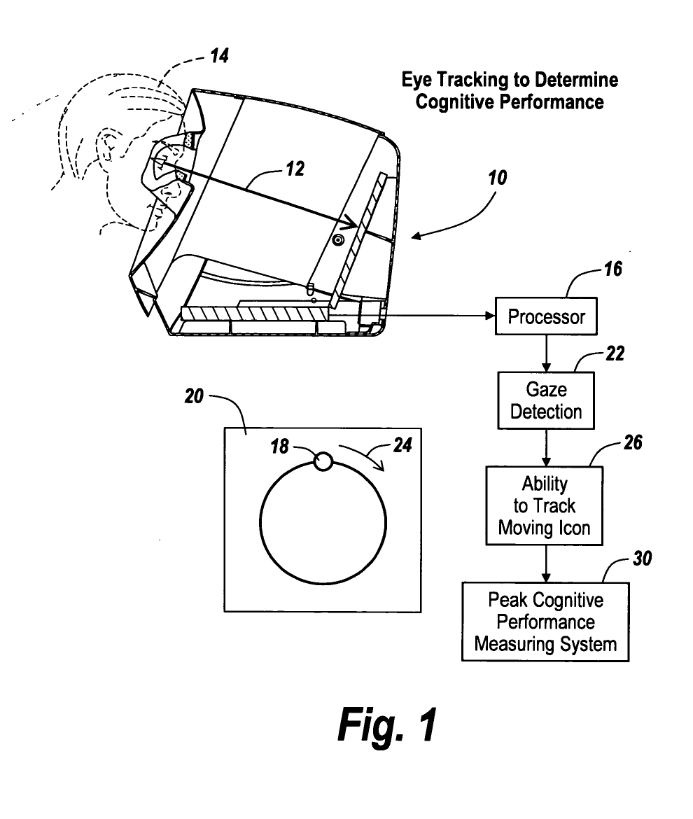

Referring now to FIG. 1, a portable eye tracking unit 10 that determines the gaze direction 12 of test subject 14 is coupled to a processor 16 which not only drives an icon 18 on a screen 20, it also detects the direction of gaze of test subject 14 as illustrated at 22. The construction of such an eye tracking device is described in U.S. patent application Ser. No. 13/507,991 filed Aug. 10, 2012 and determines when the direction of gaze 12 impinges on the moving icon, which in the indicated case moves in a circle as indicated by arrow 24. The ability to track the icon is determined at 26 which in essence measures the cognitive performance of the test subject by determining the test subject's ability to have his or her eyes track the moving icon. As described in the aforementioned patent application the ability to track the icon is often times measured in terms of the lag time or lead time of the individual's eyes in tracking the icon, called anticipatory timing.

A particularly good metric for determining the ability to track the icon is the variability in the anticipatory timing or, more particularly, the regulatory of the anticipatory timing.

Regardless, a measure of the cognitive performance of test subject 14 is applied to a peak cognitive performance measurement unit 30, the operation of which will be described hereinafter.

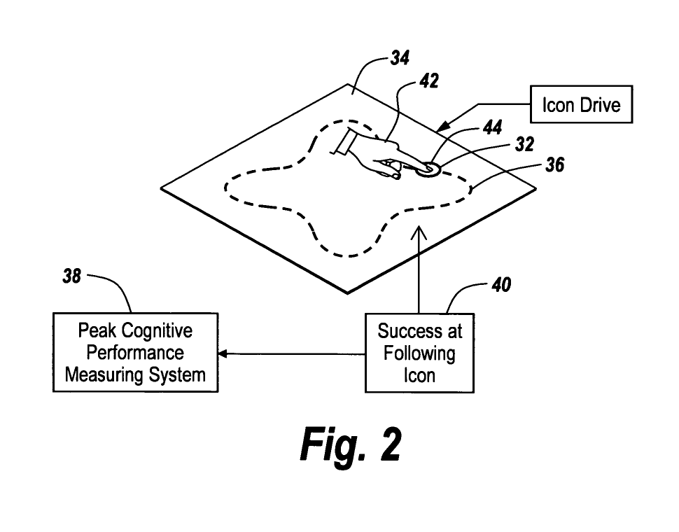

While the cognitive performance of an individual is tested utilizing eye tracking, as illustrated in FIG. 2 the ability to track a moving icon 32 on a tablet 34 that traverses a path illustrated by dotted line 36 measures cognitive performance as illustrated at 38. In order to perform the peak cognitive performance measuring, the success of following icon 32 is determined at unit 40 in much the same way as the eye tracking system of FIG. 1. In this instance the pressure of the hand 42 on tablet 34 provides an indication of the position of the end of finger 44 on tablet 34. To the extent that this position registers with the current position of the moving icon 32 then one can measure cognitive performance though the ability of the finger to track the moving icon. Note, this measures both eye tracking and manual dexterity at the same time. Said two different processes are involved, the test is exceedingly robust.

For purposes of this invention this technique is called mechanical tracking.

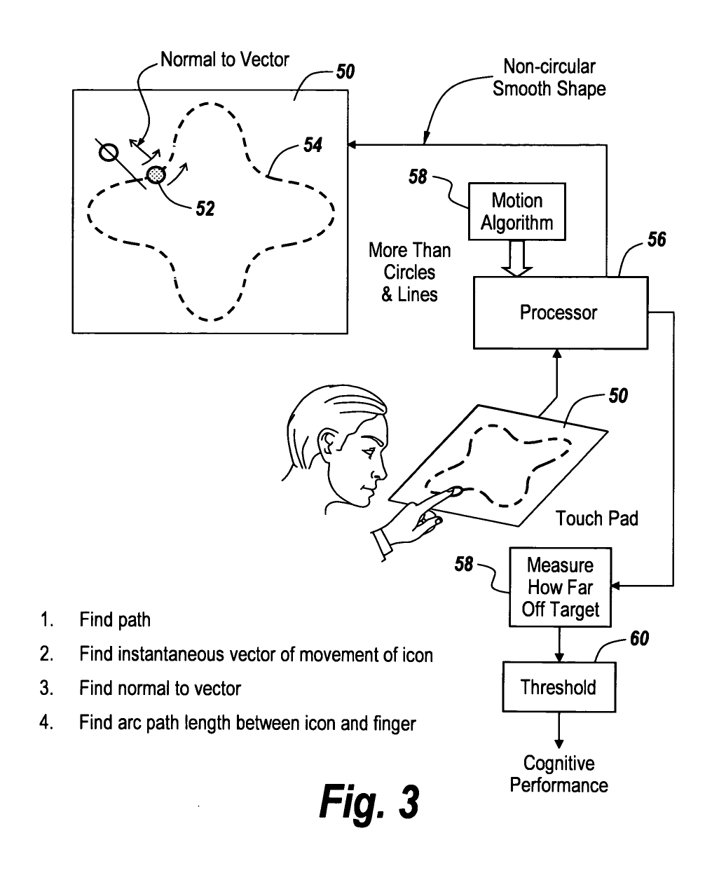

Referring now to FIG. 3, how one measures the coincidence of gaze direction or finger position to a moving icon is shown. Here a display 50 is shown in which a moving icon 52 traverses a path illustrated by dotted line 54. This path is used to promote smooth eye tracking determinations. The result of the tracking is processed by processor 56 to which a motion algorithm 58 is applied, with processor 56 driving display 50 and icon 52 thereon. It is important note that the degree of difficulty of the test depends upon the motion of the icon and the path that it traverses. For instance, a circular motion which is repetitive is easy to anticipate and therefore is the least difficult test for smooth eye pursuit. One can however produce more than circles on display 50 and the more complicated the path 54 the more difficult the test. Thus, motion algorithm 58 is capable of producing variable difficulty in the test presented to the test taker.

As illustrated at 58 as an output from processor 56 a unit determines how far off the target the eye gaze direction or the position of the person's finger is and therefore establishes through the aforementioned anticipatory timing a level of cognitive performance. It will be appreciated that the maximum level of cognitive performance can be quantified in terms of when the individual cannot perform the test meaning he cannot track the moving icon. Thereafter a threshold 60 can be set to indicate the maximum test difficulty that the individual can successfully complete.

In order to measure the coincidence of either the gaze direction or the finger, one can find the path, find an instantaneous vector of movement of the icon, find a normal to the vector and thereafter find the arc path length between the icon and either the intercept of the gaze direction with the tablet or the finger position. Having found the path arc length one can go about establishing anticipatory timing.

Regardless of the way that a measurement of cognitive performance is arrived at, it is the purpose of the subject invention to determine the peak cognitive performance.

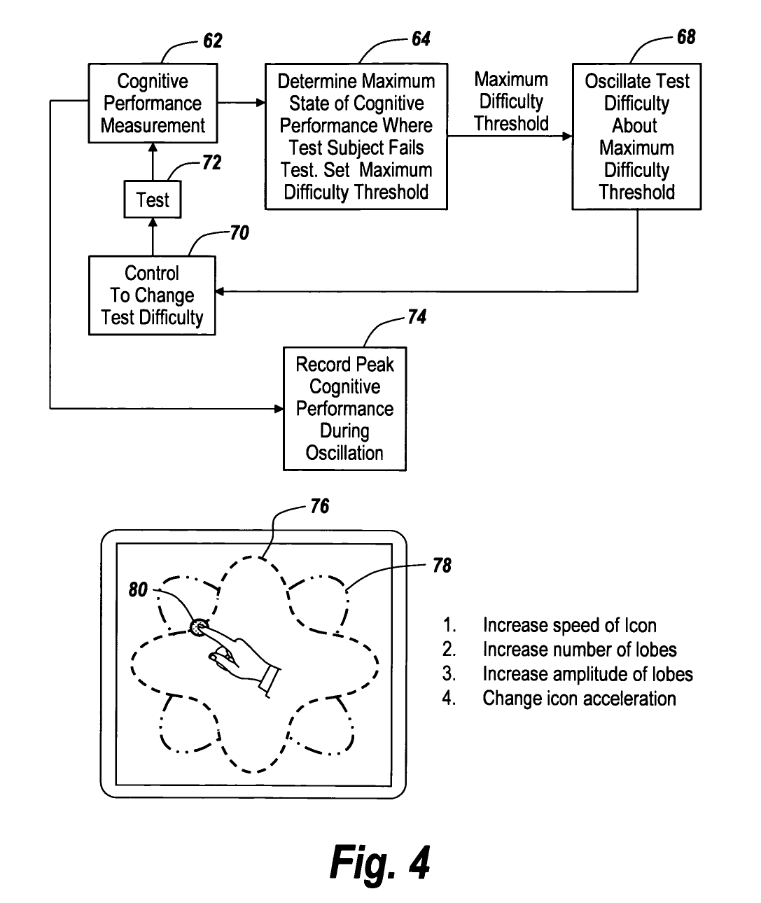

Referring now to FIG. 4, in order to do so a cognitive performance measurement 62 is performed in any manner commensurate with either smooth eye pursuit or mechanical testing. As seen by module 64 a determination is made as to the maximum state of cognitive performance where a test subject fails the test. This unit also sets a maximum difficulty threshold meaning that test difficulty below this threshold enables the individual to successfully complete the test, whereas a test difficulty above this threshold is one in which the individual taking the test cannot successfully complete the test.

The maximum difficulty threshold 66 determined in this manner is coupled to a unit 68 which oscillates the test difficulty about the maximum difficulty threshold. In order to oscillate the test difficulty the output from unit 68 is applied to a control unit 70 that changes the path movement of an icon on a screen to control test difficulty. This control unit is then coupled to a unit 72 that controls path motion in an ever increasingly or decreasingly difficult test.

Once having initiated the oscillating test difficulty algorithm what is then recorded at unit 74 is the peak cognitive performance during the oscillation. In one embodiment the peak cognitive performance is an average score for the test after a so-called stasis period has established a maximum difficulty threshold.

At the bottom of FIG. 4 is a series of paths 76 and 78 along which an icon 80 is to travel. There are various ways in which to increase the difficulty of a test, with the increase in difficulty being for instance an increase in the speed of the icon, an increase in the number of lobes of the path, an increase in the amplitude of lobes of the path or even a change in icon acceleration, with the difficulty referring to how easy or difficult it is for the individual to track the moving icon.

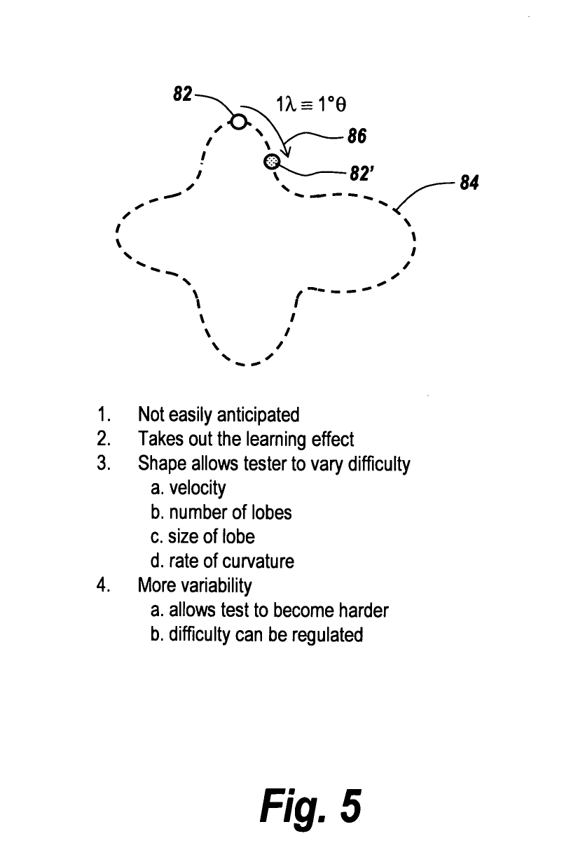

Referring now to FIG. 5, it is important to make sure that the moving icon position is not easily anticipated. Here an icon 82 is moved to a position 82′ which goes along an irregular but smooth path 84 in the direction of arrow 86. It is noted that if a non-regular path is presented to the test subject the irregular path takes out any learning effect. Moreover, the particular shape allows the testing authority to vary the difficulty of the test for instance in terms of velocity, number of lobes, size of lobe and rate of curvature or indeed any of a number of different methods by which the ability to follow the moving icon can be made harder. It will be seen that the above offers a means to vary test difficulty such that the test can become harder and in which the difficulty can be easily regulated by the differing complexity of the path on which the icon is to be moved.

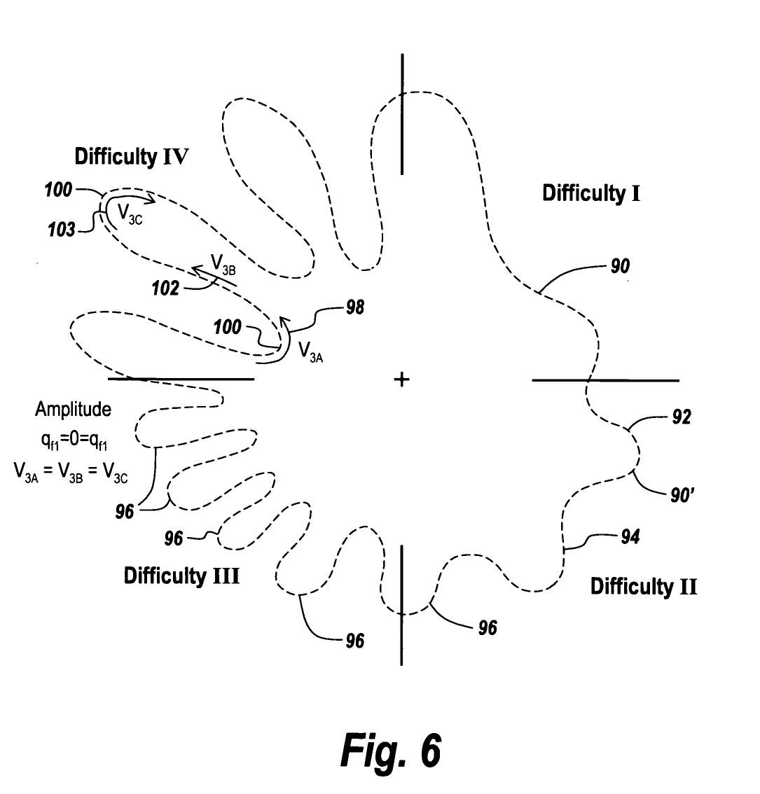

Referring to FIG. 6, what is shown is four different difficulties having to do with path configuration. Here at Difficulty I is shown by the slightly undulating path 90 which presents an icon traveling along this path. The difficulty in following the icon on this path is minimal even though the path is not easily anticipated.

Referring to Difficulty II, path 90′ is provided with an increased number of lobes here at 92, 94 and 96, with the number of lobes in a path determining the difficulty presented to the test subject.

Referring to Difficulty III, not only can the number of lobes 96 be increased dramatically, also the amplitude of the lobes can be varied such that an icon going along the paths established by these lobes will move either more or less, thus giving the test taker a challenge to be able to track the moving icon as it travels along these paths.

Finally with respect to Difficulty IV it can be seen that the velocity of the icon illustrated by arrow 98 can be of one magnitude as it moves around a lobe 100, whereas the velocity of the icon as it moves along a straight path stretch as illustrated by arrow 102 can be less. Finally the velocity of the icon illustrated by arrow 103 may be different than the velocity illustrated by arrow 98 as the icon moves around another lobe 106, such that different icon accelerations can be presented to the test taker. As a result the test difficulty can be varied in a number of different ways from a less difficult test to a more difficult test, thereby to provide different test difficulties for the subject taking the test.

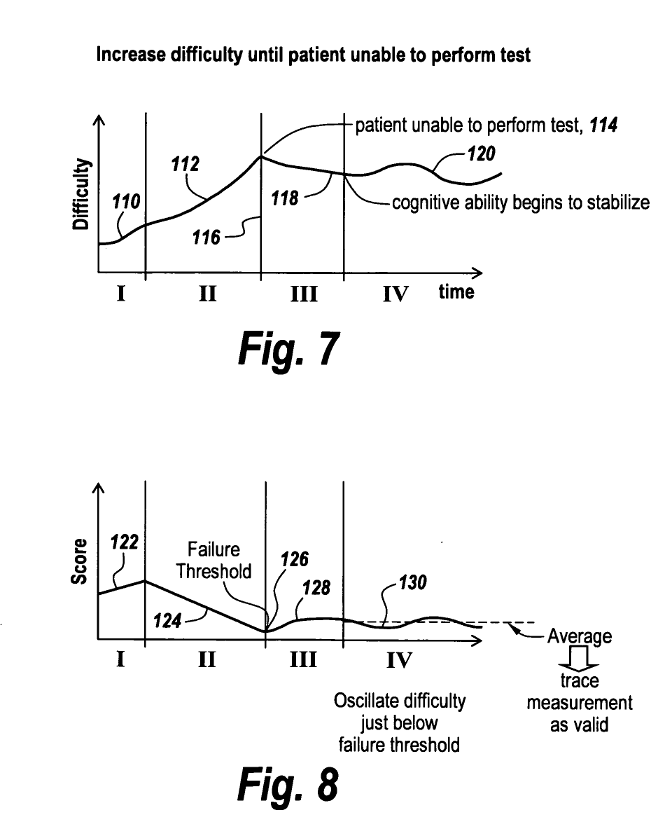

Referring now to FIG. 7, what is shown that the test is administered in one embodiment in a number of phases. Phase I relates to the initiation of the test in which initial matching is detected for a prescribed set of path motion. Here the test difficulty is either held constant much as illustrated at 110. After initialization such that the individual is comfortable in taking the test, there is a calibration phase. This is shown by the slight variation of test difficulty. Thereafter in phase II the test difficulty is ramped up significantly as illustrated 112 until such time as the patient or test taker is unable to perform the test as illustrated at 114 by a line 116 that denotes the point at the end of phase II that establishes a threshold. Thereafter as illustrated at phase III the test difficulty is varied very little as illustrated at 118 to provide a stasis period to be able to stabilize on the cognitive ability of the test taker. At the end of phase III the cognitive ability of the test taker is ascertained and more particularly his maximum ability to achieve. For phase IV the test difficulty is oscillated around this threshold level as illustrated at 120.

All the time that the tests are being performed in varying degrees of difficulty the test taker is scored and the scores are presented as illustrated in FIG. 8. Here it can be seen that during phase I the score of the test taker improves as he gets used to taking the test as illustrated by line 122. Thereafter when the test difficulty is ramped up the score 124 decreases to a failure at a threshold point as illustrated at 126. This failure threshold point is utilized in establishing when the individual is in a relatively stable mode or in stasis, and this is illustrated by the test score illustrated by line 128.

Upon reaching stasis, the test difficulty is oscillated around the aforementioned threshold and the test score as illustrated by line 130 reflects this such that the test scores reflect oscillation in difficulty just below the threshold level. The average during oscillation provides an accurate indication as to the peak cognitive performance capabilities of the test taker.

It is because one is able to make accurate initial cognitive performance measurements and then to vary the difficulty of the test and oscillate the difficulty around a threshold that the average trace measurement is a valid indicator of peak cognitive performance.

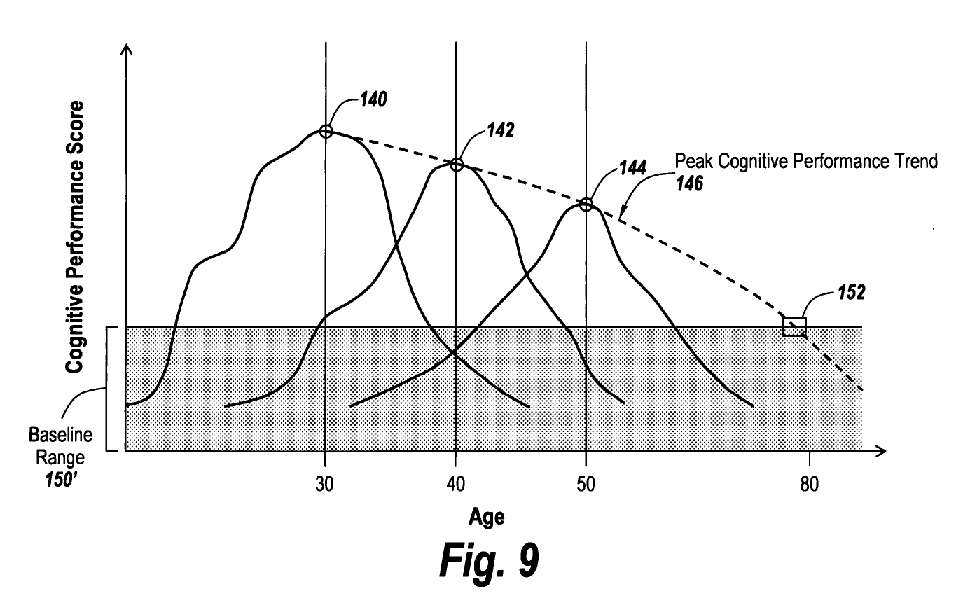

Referring to FIG. 9, having ascertained peak cognitive performance, this metric can be used over time to measure a decreasing trend of cognitive impairment with age. Here cognitive peaks 140, 142 and 144 taken at 10 gear intervals indicate a decreasing cognitive performance trend indicated by dotted line 146. When this trend is compared with a baseline range 150 one can predict when cognitive performance falls below the baseline range as illustrated at 152. The steepness of trend line 146 is oftentimes a good predictor of the presence of a mental condition such as dementia or Alzheimer's disease. One could predict the likelihood of later life Alzheimer's disease or its onset by establishing the subject peak cognitive performance trend. The ability to accurately keep track of peak cognitive performance has many uses in both diagnostics and for instance the efficacy of cognitive enhancement drugs, with trend lines indicating improvement in cognitive performance when using such drugs. In short, an accurate robust measure of peak cognitive performance opens up many avenues for evaluation and are all due to the ability to robustly measure peak cognitive performance through smooth pursuit tracking and the ability to vary test difficulty.

The mathematical definitions of the metrics used herein are presented below:

### Anticipatory Timing:

$$f ( f ) = \frac{1}{N} {\sum }_{j = 1}^{N} ( {\sum }_{i = 1}^{N} {( \vert t - i \vert )}_{ij} - {\sum }_{i = 1}^{N} {( \vert t - i \vert )}_{i} )$$

The standard deviation of the sum of the absolute value of a set of target position arrays subtracted from a set of user position arrays.
N=The length of the target position (the number of elements in the array).
j=The standard deviation index for the absolute value target minus user array
i=The index for the sum of absolute value target minus user array
t=Target position arrays.
i=User position arrays.

### Variability:

$$f ( e ) = \frac{1}{{N}^{2}} {\sum }_{k = 1}^{N} {( {\sum }_{j = 1}^{N} {( {( {d}_{t} - {d}_{i} )}_{j} - ( {d}_{t} \overline{-} {d}_{i} ) )}_{k} - {\sum }_{j = 1}^{N} ( {( {d}_{t} - {d}_{i} )}_{j} - ( {d}_{t} \overline{-} {d}_{i} ) ) )}^{2}$$

The variance of the standard deviation of a set of target position arrays subtracted from a set of user position arrays.
N=The length of the target position (the number of elements in the array).
j=The standard deviation index.
k=The variance index.
dt=Target distance arrays.
di=User distance arrays.

### Regularity:

$$f ( e ) = Minimum [ {{δ}_{t = 0}}^{t = f} ( {\sum }_{i = 0}^{i = N} e ) ]$$

Finding the minimum of the application of the sum of an error array on a delta distribution.
e=Error array.
N=The length of the target position (the number of elements in the array).
t=Time.
i=Index of error array.

### Predictability:

ƒ(t+1)=kf(t₋ₙ,t₀)

A factor of k applied to any function listed on this sheet.
k=Arbitrary constant.
t=Input elements to any function f.

### Peak Performance:

ƒ(p)=Maximum[scores[t₀:t_{ƒ}]]

The maximum value of any indexed portion of the scores array.
to=Beginning index.
tf=Ending index.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for quantifying peak cognitive performance comprising the steps of:
utilizing smooth pursuit icon tracking to measure cognitive performance;
varying the difficulty of the smooth eye performance test until the test taker can no longer track the icon; and
measuring the test taker's performance with a test difficulty slightly less difficult than the test at which the test taker failed the test.

2. The method of claim 1, and further including oscillating the test difficulty of the test difficulty level just below which the test taker has failed the test.

3. In a smooth pursuit testing scenario a method for quantifying peak cognitive performance comprising the step of: increasing the difficulty of the smooth pursuit test until such time as a test subject can no longer perform the test and recording a test score corresponding to the point at which the test taker has failed the test.

4. The method of claim 3, wherein the testing for quantifying peak cognitive performance is replicated at a number of different ages of a test subject.

5. The method of claim 4, wherein the peak performance is registered for each of consecutive ages of the test subject and further subject including the step of calculating the decrease in cognitive performance over time to establish a decline in peak cognitive performance trend as a function of age.

6. The method of claim 5, and further including the step of establishing a baseline range.

7. The method of claim 6, and further including the step of determining where the peak cognitive performance trend drops below the baseline range, thereby to establish the age at which the test subject cognitive impairment is projected to set in.

8. The method of claim 7, wherein falling below the baseline range peak cognitive performance test indicates age impairment.

9. The method of claim 3, wherein the cognitive impairment includes, one of Alzheimer's disease and dementia.

10. The method of claim 3, wherein the smooth pursuit tracking scenario includes the ability of a test subject to track a moving icon.

11. The method of claim 10, wherein the smooth pursuit tracking scenario includes one of mechanical tracking or eye tracking.

12. The method of claim 3, wherein the metric utilized to measure cognitive performance and thus peak cognitive performance includes one of anticipatory timing, variability as to how far off target the test individual is, regularity of the smooth pursuit measurement, and predictability.

13. The method of claim 3, wherein peak cognitive performance is quantified by measuring the ability of an individual to track a moving icon.

14. The method of claim 13, wherein the ability to track a moving icon includes measuring how far off the target and individuals track of the icon is.

15. The method of claim 3, wherein the smooth pursuit testing scenario includes cognitive performance enhancement testing having a controllable test difficulty and determining the cognitive performance of a test subject in terms of when the test subject fails the test, obtaining a maximum difficulty threshold responsive thereto, oscillating the test difficulty below the maximum difficulty threshold, detecting peak cognitive performance during the oscillation and ascertaining any detected enhancement in cognitive performance.

16. The method of claim 3, wherein the test subject is subjected to a smooth pursuit test involving a moving icon and wherein as Phase I initiation, the test proceeds in which initial matching is detected for a prescribed path of the moving icon in which test difficulty is kept constant and further including as step Phase II, ramping up the test difficulty over that associated with the Phase I until the test subject is unable to perform to establish a threshold, followed by a Phase III in which test difficulty remains unchanged to provide stasis to stabilize the cognitive ability of the test subject taker, followed by Phase IV in which the test difficulty is oscillated just below the failure threshold and further including the step of averaging the results to provide an average measurement of peak performance.

17. A method for establishing a peak cognitive performance score using physical apparatus in establishing peak cognitive performance.

18. The method of claim 17, wherein the physical apparatus includes a smooth pursuit testing unit.

19. The method of claim 18, wherein the smooth pursuit testing unit includes smooth pursuit eye tracking apparatus.

20. The method of claim 17, wherein the physical apparatus includes smooth pursuit mechanical tracking apparatus.

21. A method for improving in cognitive performance comprising the steps of;
performing a smooth pursuit cognitive performance test over a number of time periods; and,
establishing therefrom an improvement in cognitive performance.

22. The method of claim 21, wherein the smooth pursuit cognitive performance test is made using one of eye tracking apparatus or mechanical apparatus.

23. The method of claim 21, wherein the peak cognitive performance is established by varying the difficulty of the smooth pursuit cognitive performance test and establishing when a test subject fails the smooth pursuit cognitive performance test.

24. The method of claim 23, wherein the cognitive impairment includes, one of Alzheimer's disease and dementia.

25. The method of claim 23, wherein the smooth pursuit tracking cognitive performance test includes the ability of a test subject to track a moving icon.

26. The method of claim 25, wherein the smooth pursuit tracking cognitive performance test includes one of mechanical tracking or eye tracking.

27. The method of claim 21, wherein the metric utilized to measure cognitive performance and thus peak cognitive performance includes one of anticipatory timing, variability as to how far off target the test individual is, regularity of the smooth pursuit measurement, and predictability.

28. The method of claim 21, wherein peak cognitive performance is quantified by measuring the ability of an individual to track a moving icon.

29. The method of claim 28, wherein the ability to track a moving icon includes measuring how far off the target and individuals track of the icon is.

30. The method of claim 21, wherein the smooth pursuit cognitive performance test includes cognitive performance enhancement testing having a controllable test difficulty and determining the cognitive performance of a test subject in terms of when the test subject fails the test, obtaining a maximum difficulty threshold responsive thereto, oscillating the test difficulty below the maximum difficulty threshold, detecting peak cognitive performance during the oscillation and ascertaining any detected enhancement in cognitive performance.

31. The method of claim 21, wherein the test subject is subjected to a smooth pursuit test involving a moving icon and wherein as Phase I initiation, the test proceeds in which initial matching is detected for a prescribed path of the moving icon in which test difficulty is kept constant and further including as step Phase II, ramping up the test difficulty over that associated with the Phase I until the test subject is unable to perform to establish a threshold, followed by a Phase III in which test difficulty remains unchanged to provide stasis to stabilize the cognitive ability of the test subject taker, followed by Phase IV in which the test difficulty is oscillated just below the failure threshold and further including the step of averaging the results to provide an average measurement of peak performance.

32. A method for establishing when after the intake of a substance a test subject has a favorable response to the intake, comprising the steps of;
performing a peak cognitive performance test prior to the intake of the substance; and
repeating the peak cognitive performance test after the intake to establish a favorable response by comparing the results prior to and after the intake of the substance to establish an improvement in cognitive performance.

33. The method of claim 32, wherein the peak cognitive performance test includes smooth cognitive performance testing.

34. The method of claim 33, wherein the peak cognitive performance test includes the use of at least one of eye tracking cognitive performance testing or mechanical cognitive performance testing.

35. Apparatus for quantifying cognitive performance, comprising:
a cognitive performance measuring device adapted to be used to measure cognitive performance of a test taker, said measuring device utilizing smooth pursuit icon tracking to measure cognitive performance in which cognitive performance of said test taker is measured by one of anticipatory timing, variability as to how far off target the test taker is, regularity of the smooth pursuit measurement and predictability, said measuring device including a manual icon tracking device.

36. The apparatus of claim 35, wherein said manual icon tracking device includes a tablet on which is presented a moving icon that executes a smooth pursuit path.

37. The apparatus of claim 36, wherein the response of said test taker to the movement of the icon is recorded by sensing the position of the finger of said test taker on said tablet as said test taker seeks to move his finger to correspond to the position of said moving icon.
